(19) United States
(12) Patent Application Publication
(10) Pub. No.: US 2023/0387432 A1
(43) Pub. Date: Nov. 30, 2023

(54) METHOD FOR ASCERTAINING THE RELATIVE HUMIDITY AT A CATHODE INLET OF A FUEL CELL STACK OF A FUEL CELL SYSTEM

(71) Applicant: AVL List GmbH, Graz (AT)

(72) Inventor: Thomas SCHUBERT, Sankt Marein bei Graz (AT)

(73) Assignee: AVL List GmbH, Graz (AT)

(21) Appl. No.: 18/032,822

(22) PCT Filed: Oct. 19, 2021
(86) PCT No.: PCT/AT2021/060387

§ 371 Date: Apr. 20, 2023

(30) Foreign Application Priority Data
Oct. 20, 2020 (AT) A50898/2020

(51) Int. Cl. H01M 8/04492; H01M 8/0438; H01M 8/0432; H01M 8/04537; H01M 8/04119; H01M 8/04828

(52) U.S. Cl. CPC H01M 8/04507; H01M 8/04395; H01M 8/04335; H01M 8/04589; H01M 8/04126; H01M 8/04835

(57) ABSTRACT

The present method relates to a method for ascertaining the relative humidity (RH) at a cathode inlet (113) of a fuel cell stack (110) of a fuel cell system (100), having the following steps:
detecting at least one physical supply air parameter (ZP) of a supply air (ZU) to the cathode inlet (113),
detecting a supply air mass flow (ZM) of the supply air (ZU),
determining a supply air water mass flow (ZWM) on the basis of the at least one supply air parameter (ZP) detected and of the supply air mass flow (ZM) detected,
detecting at least one physical cathode inlet parameter (KP) at the cathode inlet (113),
determining a humidifier water mass flow (BWM) on the basis of the at least one cathode inlet parameter (KP) detected using a humidifier characteristic map (BK),
ascertaining the relative humidity (RH) at the cathode inlet (113) on the basis of the supply air water mass flow (ZWM) determined, the humidifier water mass flow (BWM) determined and the at least one cathode inlet parameter (KP) detected.

The present invention relates to a method for ascertaining the relative humidity at a cathode inlet of a fuel cell stack of a fuel cell system, an ascertaining device for carrying out such a method and a generation method for generating a humidifier characteristic map for use in a method according to the invention.

It is known that, when operating fuel cell systems, knowledge of the relative humidity within the fuel cell stack represents a crucial control parameter. This is due in particular to the fact that membranes are used in fuel cells which should not fall below a minimum humidity level. A membrane that is too dry or a membrane with too greatly variable a humidity would become damaged. In addition, it is often necessary to avoid excessive moisture in order to avoid condensation in the form of liquid water within the fuel cell stack.

Known fuel cell systems therefore usually have humidity sensors which are able to determine the relative humidity in a supply air to the fuel cell stack. It is also known for the supply air to a fuel cell stack to be actively humidified by supplying water and evaporating the water if the supply air sucked in from the environment does not contain the moisture necessary for the current point in time. For this purpose, humidifiers are provided in fuel cell systems which are able to load the supply air with additional moisture. It is also known for the humidifier to be operated passively by recirculating humidified cathode air. In this case, the transport of moisture is effected through differing partial pressures and their equalisation.

A disadvantage of the known solutions is that humidity sensors must be installed in the respective positions for effective control of the relative humidity. For example, it may be necessary to install a humidity sensor directly within the fuel cell in the vicinity of the membrane. However, it is at least necessary to impinge within the fuel cell to such an extent that a corresponding humidity sensor is arranged in the supply line to a cathode section of a fuel cell stack in order to be able to measure the desired parameter there. This leads to a high complexity in terms of design, since corresponding installation space and cabling must be provided for such a humidity sensor. It should also be noted that, depending on the quality of the sensor used, measured parameters may exhibit an inaccuracy in measurement which, accordingly, results in an inaccuracy in control. Last but not least, it should be noted that real sensors for determining the relative humidity naturally also increase the costs of manufacturing such a fuel cell system.

It is therefore the object of the present invention to remedy, at least partially, the above disadvantages. In particular, it is the object of the present invention to improve, in a cost-effective and simple manner, the control of humidity within a fuel cell system.

The above object is achieved by a method having the features of claim 1, an ascertaining device having the features of claim 8 and a generation method having the features of claim 12. Further features and details of the invention are disclosed in the dependent claims, the description and the drawings. Naturally, features and details described in connection with the method according to the invention also apply in connection with the ascertaining device according to the invention and the generation method according to the invention and vice versa, so that, with regard to disclosure, mutual reference is or can always be made to the individual aspects of the invention.

According to the invention, a method serves to ascertain the relative humidity at a cathode inlet of a fuel cell stack of a fuel cell system. For this purpose, the method comprises the following steps:
detecting at least one physical supply air parameter of a supply air to the cathode inlet,
detecting a supply air mass flow of the supply air,
determining a supply air water mass flow on the basis of the at least one supply air parameter detected and of the supply air mass flow detected,
detecting at least one physical cathode inlet parameter at the cathode inlet,
determining a humidifier water mass flow on the basis of the at least one cathode inlet parameter detected using a humidifier characteristic map,
ascertaining the relative humidity at the cathode inlet on the basis of the supply air water mass flow determined, the humidifier water mass flow determined and the at least one cathode inlet parameter detected.

The fundamental object of a method according to the invention is to completely avoid a physically present relative humidity sensor and nonetheless ascertain a value for the relative humidity. To ensure this, a method according to the invention makes use of sensor parameters which are of fundamental importance for the operation of the fuel cell system and are therefore provided by sensors which are necessarily present. To ensure this, the inventive method is based on two separate upstream steps which are then combined in a downstream ascertaining step. The individual steps will be explained in more detail below.

In the first upstream step, a supply air water mass flow is determined. This refers to the mass flow which corresponds to the amount of water in the supply air per unit of time. In other words, the amount of water that is introduced into the system from outside the fuel cell system by the supply air is determined over time. The correspondingly necessary sensors for the supply air parameters can be installed in a corresponding intake duct, but also in the environment of the fuel cell system. In order to determine this supply air water mass flow, two different pieces of information are essentially necessary. On the one hand, at least one physical supply air parameter is determined. An example of such a physical supply air parameter can for example be the supply air temperature, the supply air pressure or the relative supply air humidity. Due to the fact that the measurement of the supply air can take place at the inlet to the fuel cell system or even outside of the fuel cell system in the surrounding environment, these environmental parameters can be determined very simply and cost-effectively. In particular, a corresponding sensor system for determining the at least one physical supply air parameter may be designed to be independent or substantially independent of the fuel cell system and in particular does not have to be integrated into it. This already allows decisive advantages to be achieved with regard to the necessary installation space and weight of the fuel cell system. Based on the at least one physical supply air parameter and the supply air mass flow of the supply air, i.e. the mass flow of the entire supply air, a supply air water mass flow can be determined. This determination takes place either in an algorithmic, i.e. physically calculable relationship, or using a characteristic map, which will be explained later, or other relationships, for example using a neural network.

Parallel to and separately from this determination of the supply air water mass flow, a determination of the humidifier water mass flow takes place. This is the amount of water per unit of time which is mixed with the supply air by the humidifier. The humidifier is a physically present humidifier unit of the fuel cell system and is able to introduce additional moisture into the supply air and thus increase the relative humidity of the supply air in a controllable manner. In order to determine this humidifier water mass flow, at least one physical cathode inlet parameter is determined, which is then used for the determination. Physical cathode inlet parameters will be explained in more detail below and refer, for example, to the cathode inlet temperature, the cathode inlet pressure or the current requirement at the fuel cell stack. From one or more of these cathode inlet parameters it is now possible, in an inventive manner, to determine a humidifier water mass flow using a humidifier characteristic map.

At this point, the use of the humidifier characteristic map makes it possible to dispense with a humidity sensor integrated into the fuel cell system. While, in the known solutions, physically present humidity sensors had to be integrated into the fuel cell system, according to the invention a determination of the humidifier water mass flow based on the humidifier characteristic map can be carried out using existing control parameters of the fuel cell system in the form of the at least one cathode inlet parameter. This clearly illustrates a core advantage of the present invention.

In a final and combining step, the determined supply air water mass flow and the determined humidifier water mass flow are combined and used together with at least one cathode inlet parameter to ascertain the relative humidity at the cathode inlet. This now allows the relative humidity at the cathode inlet to be ascertained without a humidity sensor integrated into the fuel cell system. This final ascertaining step can also be determined using an additional characteristic map or a physically based algorithmic relationship. This ascertaining is, accordingly, preferably based on a physically verifiable relationship between the input parameters described.

In addition to the great advantage of the possibility of dispensing with a physically present humidity sensor, the time at which the relative humidity is ascertained is improved. This is based in particular on the fact that a prediction can already be made, as the supply air is flowing through the humidifier, as to which relative humidity will be achieved at the cathode inlet in the current operating situation. This prediction makes it possible to react in a controlling manner, for example through an adjustment intervention, earlier than with the known solutions, and thus to avoid undesirable fluctuations in regulation or control. Thus, if an excessively low relative humidity at the cathode inlet is predicted, countermeasures can be taken earlier, compared to the known solutions with physically present humidity sensors, so that in real operation the relative humidity at the membrane in the respective fuel cell decreases less sharply than would be the case with the known solutions. A method according to the invention thus also makes it possible to improve the subsequent success of control measures.

It can bring advantages if, in a method according to the invention, at least one of the following is used as supply air parameter:
supply air temperature,
supply air pressure,
relative supply air humidity.

The above list is a non-exhaustive list. In particular, at least two, or exactly the above three different supply air parameters are used for a method according to the invention. Moreover, the above supply air parameters are parameters for which sensors are fundamentally provided for the normal regulating operation of a fuel cell system. In particular, it should be noted that a sensor means for ascertaining the relative supply air humidity can be arranged independently of the fuel cell system, i.e. without integration into the interior of the fuel cell system.

It is also advantageous if, in a method according to the invention, at least one of the following is used as cathode inlet parameter:
current requirement,
cathode inlet temperature,
cathode inlet pressure.

The above list is a non-exhaustive list. Here, too, already existing sensor means of the fuel cell system which are necessary for the basic control of the operation of the fuel cell system are preferably used. It should in particular be emphasised that the cathode inlet parameters do not include a determination of a relative cathode inlet humidity. However, several additional parameters can be used, for example when using a method according to the invention on a test bench for fuel cell systems. As will be explained later, this can be used to generate, improve and/or validate the humidifier characteristic map. A humidifier characteristic map which is measured and generated as broadly as possible allows a method according to the invention to be used later in different fuel cell systems, either in a general manner or in a manner specified for the respective fuel cell system.

Further advantages can be achieved if, in a method according to the invention, an additional characteristic map is used to determine the supply air water mass flow and/or to ascertain the relative humidity at the cathode inlet. Thus, in addition to the humidifier characteristic map as a core idea of the present invention, an additional characteristic map can be used, as an alternative to algorithmic relationships, for said determination and said ascertainment. Such additional characteristic maps can provide the data relationships accordingly, for example in tabular form. The use of a neural network for such additional characteristic maps is also conceivable within the context of the present invention. The same applies to the humidifier characteristic map, which can be based, in a trained manner, on tabular relationships and/or neural networks.

It is also advantageous if, in a method according to the invention, a humidifier characteristic map specific to the fuel cell stack and/or the fuel cell system is used. This makes it possible to determine a specific humidifier characteristic map specific to a type of fuel cell system on a test bench. This specific form of the humidifier characteristic map can also be oriented on a specific embodiment of the respective humidifier. For example, associated specific weighting factors can be adapted to the specific configuration of a basic humidifier characteristic map. It is also possible to carry out a fully specific determination on the respective test bench in order to generate an associated specific humidifier characteristic map.

In addition, it brings advantages if, in a method according to the invention, the humidifier characteristic map is at least partially in the form of a weighted neural network. In other words, in this embodiment the humidifier characteristic map is at least partially implemented in the form of artificial intelligence, whereby the training of this neural network in the form of a deep learning algorithm can for example be obtained using corresponding data from a test bench for the fuel cell system. This applies in particular to the use of a specific humidifier characteristic map, as explained in the previous paragraph.

In addition, it can brings advantages if, in a method according to the invention, the relative humidity determined is compared with at least one limit value, wherein a control signal is generated in the event that the at least one limit is exceeded. While a method according to the invention is basically intended to provide a parameter in the form of the relative humidity for subsequent control methods, the step of evaluating this determined or ascertained relative humidity can also be integrated into the method according to the invention. If, for example, the ascertaining of the current relative humidity shows a level below a minimum relative humidity, a control signal can be output to a control method in order to actuate corresponding adjusting means in such a way that increased humidification will lead to a higher relative humidity. If an excessively high relative humidity is detected, a reduction in the relative humidity can be achieved through this comparison, for example by activating a bypass past a humidifier device.

Another object of the present invention is an ascertaining device for ascertaining the relative humidity at a cathode inlet of a fuel cell stack of a fuel cell system. Such an ascertaining device comprises a supply air module for detecting at least one physical supply air parameter of a supply air to the cathode inlet. Furthermore, this supply air module is used to detect a supply air mass flow of the supply air. The ascertaining device also comprises a supply air determining module for determining a supply air water mass flow on the basis of the at least one supply air parameter detected and the supply air mass flow detected. Using a cathode inlet module, it is possible to detect at least one physical cathode inlet parameter at the cathode inlet. In addition, a cathode inlet determining module is provided for determining a humidifier water mass flow on the basis of the at least one cathode inlet parameter detected using a humidifier characteristic map. Finally, the ascertaining device comprises an ascertaining module for ascertaining the relative humidity at the cathode inlet on the basis of the supply air water mass flow determined, the humidifier water mass flow determined and the at least one cathode inlet parameter detected. The supply air module, the supply air determining module, the cathode inlet module, the cathode inlet determining module and/or the ascertaining module are advantageously designed to carry out a method according to the invention. Thus, an ascertaining device according to the invention brings the same advantages as have been explained in detail with reference to a method according to the invention.

It can be advantageous if, in an ascertaining device according to the invention, a supply air sensor device for detecting the at least one physical supply air parameter and/or the supply air mass flow is provided. Such a supply air sensor device may comprise sensor means which are in particular formed independently of the fuel cell system. They are for example used to measure the corresponding supply air parameters at the inlet for the supply air or even directly in the environment.

Further advantages can be achieved if, in an ascertaining device according to the invention, a cathode inlet sensor device for detecting the at least one cathode inlet parameter is provided. This involves sensor means of the cathode inlet sensor device which are integrated in the fuel cell system, which, however, in particular do not include a humidity sensor.

A further object of the present invention is a generation method for generating a humidifier characteristic map for use in a method according to the invention, comprising the following steps:
operating a fuel cell stack on a test bench,
detecting the at least one physical supply air parameter,
detecting the supply air mass flow,
detecting the at least one physical cathode inlet parameter,
detecting the relative humidity at the cathode inlet,
storing the relationships between the relative humidity detected and the at least one physical supply air parameter detected, the supply air mass flow detected and the at least one physical cathode inlet parameter detected in a humidifier characteristic map.

This generation method is used to determine a humidifier characteristic map or to fill it with data in order to allow it to be used subsequently in a method according to the invention. This can be used to determine specific humidifier characteristic maps, but also to determine generally applicable humidifier characteristic maps. Such a method may even be additionally validated on the same or a similar test bench. For this purpose, a determined humidifier characteristic map is operated and the results of a method according to the invention is, in parallel, compared with the measured values of a physical humidity sensor present on the test bench.

Further advantages, features and details of the invention are explained in the following description, in which exemplary embodiments of the invention are described in detail with reference to the drawings. The features mentioned in the claims and in the description may in each case be essential to the invention individually or in any combination. In each case schematically:

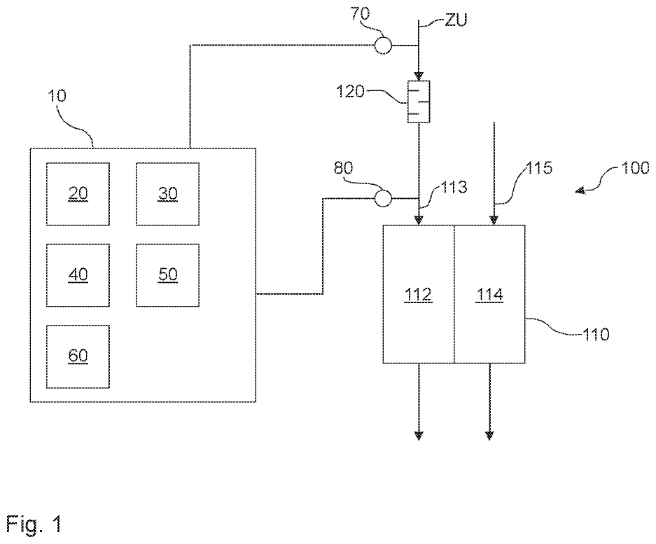

FIG. 1 shows an embodiment of an ascertaining device according to the invention,

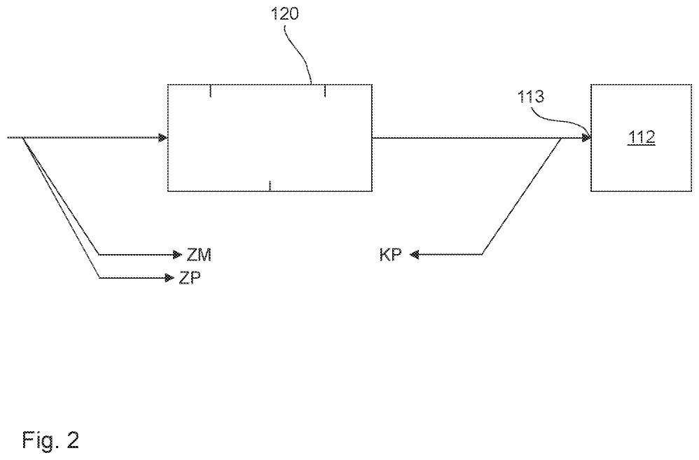

FIG. 2 shows a detail of a method according to the invention,

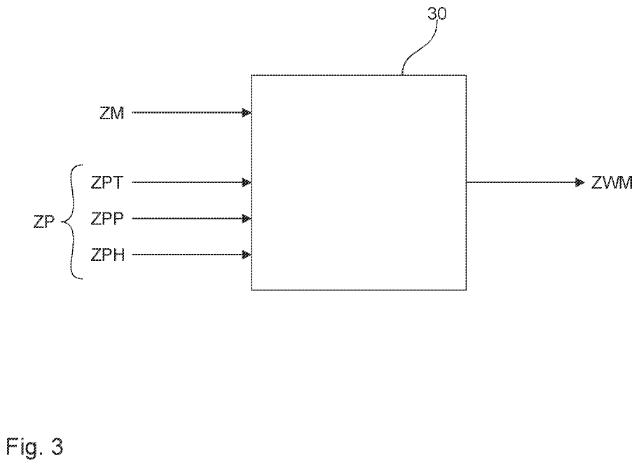

FIG. 3 shows a detail section of a method according to the invention,

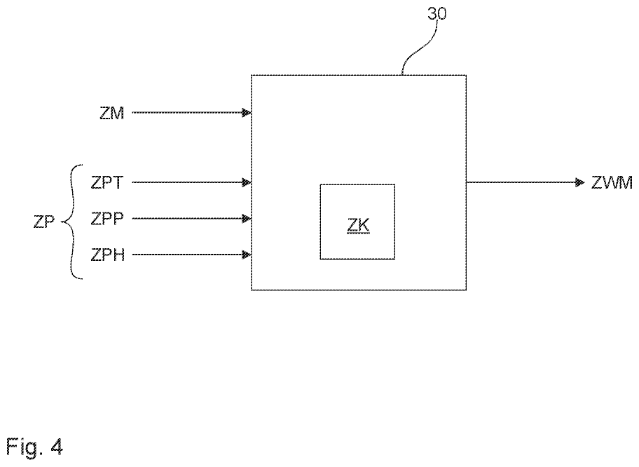

FIG. 4 shows a further detail section of a method according to the invention,

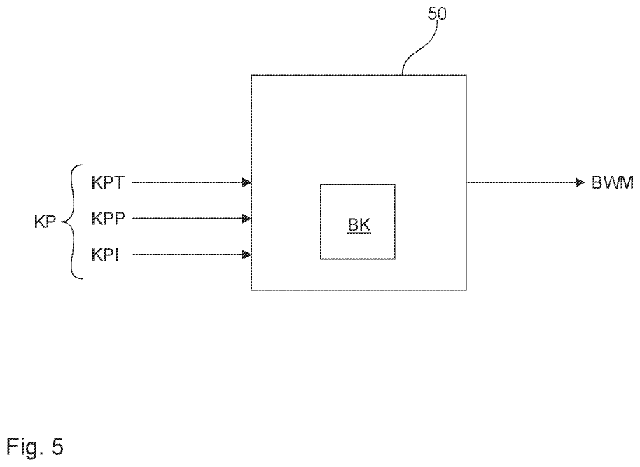

FIG. 5 shows a further detail section of a method according to the invention,

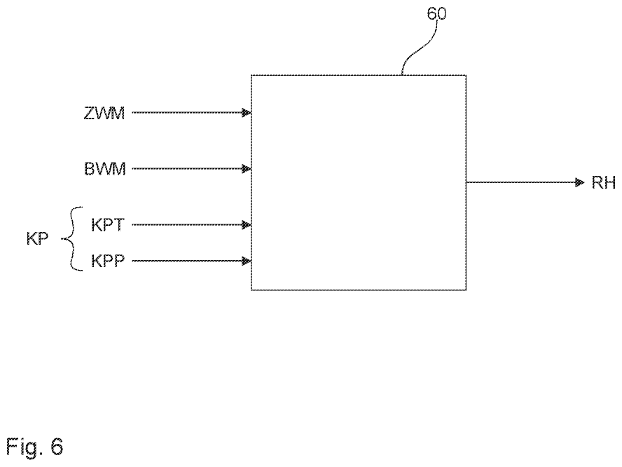

FIG. 6 shows a further detail section of a method according to the invention,

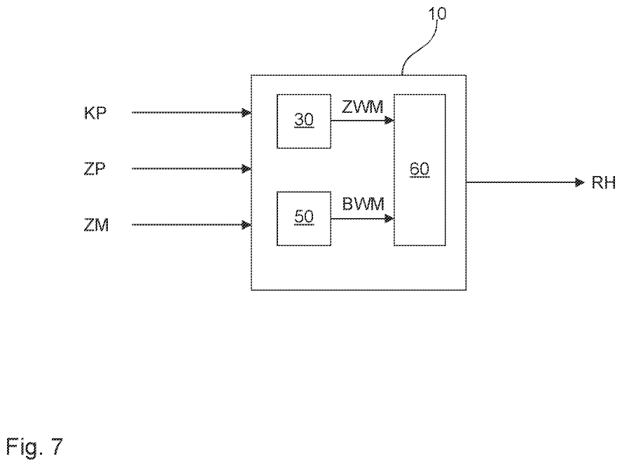

FIG. 7 shows a further detail section of a method according to the invention.

FIG. 1 shows, schematically, how a part of a fuel cell system 100 can be designed. Here, a fuel cell stack 110 is equipped with a plurality of individual fuel cells, not represented in detail, whereby the fuel cell stack 110 is divided into a cathode section 112 and an anode section 114. In order to perform the desired current-generating chemical reaction in a fuel cell stack 110, a supply and removal of the respective gases is provided. Decisive for the present invention is the cathode inlet 113 and the anode inlet 115. The key aspect here is the consideration of the cathode side, i.e. the cathode inlet 113. Here, supply air ZU is sucked in from the environment and loaded with additional moisture via a humidifier 120.

FIG. 1 shows, schematically, an ascertaining device 10 according to the invention. This is equipped with a supply air module 20, a supply air determining module 30, a cathode inlet module 40, a cathode inlet determining module 50 and an ascertaining module 60. The individual modules 20, 30, 40, 50, 60 will be explained in more detail later. A supply air sensor device 70 and a cathode inlet sensor device 80 are also provided here, which communicate in a signal-communicating manner with the ascertaining device 10 and record the desired parameters at the appropriate points.

FIG. 2 shows, schematically, the locations at which the required parameters can basically be recorded. Thus, the supply air parameter ZP and the supply air mass flow ZM are recorded in the region of the input for the supply air ZU, i.e., seen in the direction of flow, before the humidifier 120. At least one cathode inlet parameter KP is recorded downstream of the humidifier 120 in the direction of flow, in the region of the cathode inlet 113. It can already easily be seen here that no physical sensor needs to be arranged between the humidifier 120 and the cathode inlet 113 in order to ascertain the relative humidity.

According to the invention, in a first step the supply air water mass flow ZWM is determined in the supply air determining module 30, as shown in FIG. 3. At least one physical supply air parameter ZP and a supply air mass flow ZM are taken into account here in order to determine the supply air water mass flow ZWM, for example in an algorithmic relationship. In this embodiment, the supply air temperature ZPT, the supply air pressure ZPP and the relative supply air humidity ZPH are used as supply air parameters ZP.

As an alternative to the embodiment in FIG. 3, a variant is shown in FIG. 4 in which, in addition to or alternatively to an algorithmic relationship, an additional characteristic map ZK based on the input parameters leads to the determination of the supply air water mass flow ZWM.

FIG. 5 represents the second preparatory method step wherein, in the cathode inlet determining module 50, the cathode inlet parameters KP lead here to the determination of the humidifier water mass flow BWM. According to the invention, no algorithmic relationship is provided here, the humidifier characteristic map BK is used instead. In this case the cathode inlet temperature KPT, the cathode inlet pressure KPP and the current requirement KPI are used as cathode inlet parameters KPI.

FIG. 6 shows the combination of the determined values in the ascertaining module 60. The parameters supply air water mass flow ZWM and humidifier water mass flow BWM determined in the first two steps of the method are used here in addition to the already existing cathode inlet parameters KP, which have already been used once, in order to ascertain the relative humidity RH again by an algorithmic relationship or using an additional characteristic map ZK, not shown in detail. In this embodiment shown in FIG. 6, the cathode inlet temperature KPT and the cathode inlet pressure KPP are used by way of example as cathode inlet parameters KP.

Finally, FIG. 7 shows the combination of the preceding steps in an ascertaining device 10. Here again it can clearly be seen that the cathode inlet parameters KP, the supply air parameters ZP and the supply air mass flow ZM are received from outside of the ascertaining device 10. The relative humidity RH is output on the other side. Due to the two-stage nature of the method according to the invention, the supply air water mass flow ZWM and the humidifier water mass flow BWM are determined by the supply air determining module 30 and the cathode inlet determining module 50 within the ascertaining device, so to speak as intermediate results, which in the second stage of the method according to the invention are converted into the relative humidity RH via the ascertaining module 60.

The preceding explanation describes the present invention exclusively on the basis of examples. Naturally, individual features of the embodiments can, insofar as technically expedient, be combined freely with each other without departing from the scope of the present invention.

### LIST OF REFERENCE SYMBOLS

10 ascertaining device
20 supply air module
30 supply air determining module
40 cathode inlet module
50 cathode inlet determining module
60 ascertaining module
70 supply air sensor device
80 cathode inlet sensor device
100 fuel cell system
110 fuel cell stack
112 cathode section
113 cathode inlet
114 anode section
115 anode inlet
120 humidifier
ZU supply air
RH relative humidity
ZP supply air parameter
ZPT supply air temperature
ZPP supply air pressure
ZPH relative supply air humidity
ZM supply air mass flow
ZWM supply air water mass flow
KP cathode inlet parameter
KPI current requirement
KPT cathode inlet temperature
KPP cathode inlet pressure
BK humidifier characteristic map
BWM humidifier water mass flow
ZK additional characteristic map

1. Method for ascertaining the relative humidity (RH) at a cathode inlet of a fuel cell stack of a fuel cell system, having the following steps:
detecting at least one physical supply air parameter (ZP) of a supply air (ZU) to the cathode inlet,
detecting a supply air mass flow (ZM) of the supply air (ZU),
determining a supply air water mass flow (ZWM) on the basis of the at least one supply air parameter (ZP) detected and of the supply air mass flow (ZM) detected,
detecting at least one physical cathode inlet parameter (KP) at the cathode inlet,
determining a humidifier water mass flow (BWM) on the basis of the at least one cathode inlet parameter (KP) detected using a humidifier characteristic map (BK),
ascertaining the relative humidity (RH) at the cathode inlet on the basis of the supply air water mass flow (ZWM) determined, the humidifier water mass flow (BWM) determined and the at least one cathode inlet parameter (KP) detected.

2. Method according to claim 1, wherein at least one of the following is used as supply air parameter (ZP):
supply air temperature (ZPT)
supply air pressure (ZPP)
relative supply air humidity (ZPH)

3. Method according to claim 1, wherein at least one of the following is used as cathode inlet parameter (KP):
current requirement (KPI)
cathode inlet temperature (KPT)
cathode inlet pressure (KPP)

4. Method according to claim 1, characterised in that an additional characteristic map (ZK) is used to determine the supply air water mass flow (ZWM) and/or to ascertain the relative humidity (RH) at the cathode inlet.

5. Method according to claim 1, wherein a humidifier characteristic map (BK) specific to the fuel cell stack and/or the fuel cell system is used.

6. Method according to claim 1, wherein the humidifier characteristic map (BK) is at least partially in the form of a weighted neural network.

7. Method according to claim 1, wherein the relative humidity (RH) ascertained is compared with at least one limit value, wherein a control signal is generated in the event that the at least one limit is exceeded.

8. Ascertaining device for ascertaining the relative humidity (RH) at a cathode inlet of a fuel cell stack of a fuel cell system, comprising a supply air module for detecting at least one physical supply air parameter (ZP) of a supply air (ZU) to the cathode inlet and detecting a supply air mass flow (ZM) of the supply air (ZU), further comprising a supply air determining module for determining a supply air water mass flow (ZWM) on the basis of the at least one supply air parameter (ZP) detected and the supply air mass flow (ZM) detected, further comprising a cathode inlet module for detecting at least one physical cathode inlet parameter (KP) at the cathode inlet, further comprising a cathode inlet determining module for determining a humidifier water mass flow (BWM) on the basis of the at least one cathode inlet parameter (KP) detected using a humidifier characteristic map (BK), further comprising an ascertaining module for ascertaining the relative humidity (RH) at the cathode inlet on the basis of the determined supply air water mass flow (ZWM), the humidifier water mass flow (BWM) determined and the at least one cathode inlet parameter (KP) detected.

9. Ascertaining device according to claim 8, wherein the supply air module, the supply air determining module, the cathode input module, the cathode inlet determining module and/or the ascertaining module are designed to carry out a method for ascertaining the relative humidity (RH) at a cathode inlet of a fuel cell stack of a fuel cell system, having the following steps:
detecting the at least one physical supply air parameter (ZP),
detecting the supply air mass flow (ZM),
determining the supply air water mass flow (ZWM) on the basis of the at least one supply air parameter (ZP) detected and of the supply air mass flow (ZM) detected,
detecting the at least one physical cathode inlet parameter (KP).

10. Ascertaining device according to claim 8, wherein a supply air sensor device is provided to detect the at least one physical supply air parameter (ZP) and/or the supply air mass flow (ZM).

11. Ascertaining device according to claim 8, wherein a cathode inlet sensor device is provided to detect the at least one cathode inlet parameter (KP).

12. A generation method for generating a humidifier characteristic map (BK) for use in a method having the features of claim 1, comprising the following steps:
operating a fuel cell stack (110) on a test bench,
detecting the at least one physical supply air parameter (ZP),
detecting the supply air mass flow (ZM),
detecting the at least one physical cathode inlet parameter (KP),
detecting the relative humidity (RH) at the cathode inlet (113),
storing the relationships between the relative humidity (RH) detected and the at least one physical supply air parameter (ZP) detected, the supply air mass flow (ZM) detected and the at least one physical cathode inlet parameter (KP) detected in a humidifier characteristic map (BK).
